(19) United States
(12) Patent Application Publication
(10) Pub. No.: US 2024/0236468 A9
(43) Pub. Date: Jul. 11, 2024

(54) Smart Mirror Device

(71) Applicant: Ashley Moore, Birmingham, AL (US)

(72) Inventor: Ashley Moore, Birmingham, AL (US)

(21) Appl. No.: 18/489,889

(22) Filed: Oct. 19, 2023

Related U.S. Application Data
(60) Provisional application No. 63/417,442, filed on Oct. 19, 2022.

(51) Int. Cl. H04N 23/56; A47G 1/02; H04N 23/62; H04N 23/66; H04N 23/74; H05B 47/155; H05B 47/19

(52) U.S. Cl. CPC H04N 23/56; A47G 1/02; H04N 23/62; H04N 23/66; H04N 23/74; H05B 47/155; H05B 47/19; A47G 2200/08

(57) ABSTRACT

The present invention relates to a smart minor device. The device is primarily comprised of a frame with a first side having at least one first mirror with at least one light source and a second side having at least one second mirror with at least one camera. A user can use the light sources on the first and second sides to illuminate the minor and the surrounding area. A user can also use the camera on the second side to take a picture and/or a video of themselves. The light sources and camera can be controlled by a mobile application.

### CROSS-REFERENCE TO RELATED APPLICATION

The present application claims priority to, and the benefit of, U.S. Provisional Application No. 63/417,442, which was filed on Oct. 19, 2022, and is incorporated herein by reference in its entirety.

### FIELD OF THE INVENTION

The present invention relates generally to the field of mirrors. More specifically, the present invention relates to a smart mirror device primarily comprised of a frame with a first side having at least one first mirror with at least one light source and a second side having at least one second minor with at least one camera. A user can use the light source on the first and second sides to illuminate the mirror and the surrounding area. A user can also use the camera on the second side to take a picture and/or a video of themselves via a mobile application. Accordingly, the present disclosure makes specific reference thereto. Nonetheless, it is to be appreciated that aspects of the present invention are also equally applicable to other like applications, devices, and methods of manufacture.

### BACKGROUND

Individuals who want to take a “selfie” in a mirror must hold their smart device in their hand to do so. This takes away from the overall aesthetic of the photo and is undesirable. In addition, most mirrors reverse images in the mirror. This does not present to a user how they are actually perceived. In addition, mirrors cannot show the side of a user that is not facing the mirror. Furthermore, many rooms with mirrors lack proper lighting to allow a user to properly view themselves in the mirror, and to take adequately lighted pictures.

Therefore, there exists a long-felt need in the art for an improved mirror. More specifically, there exists a long-felt need in the art for a smart mirror device. There also exists a long-felt need in the art for a smart mirror device that provides adequate lighting. In addition, there exists a long-felt need in the art for a smart mirror device that allows a user to take a photo or video using the mirror without having to have their smart device in the picture. Further, there exists a long-felt need in the art for a smart mirror device that can show a user a 360-degree view of their entire outfit.

The subject matter disclosed and claimed herein, in one embodiment thereof, comprises a smart minor device. The device is comprised of a smart mirror device primarily comprised of a frame with a first side having at least one first minor with at least one light source and a second side having at least one second mirror with at least one camera. A user can use the light source on the first side to illuminate the mirror and the surrounding area. A user can also use the light source on the second side to illuminate the mirror and the surrounding area. In addition, a user can use the camera on the second side to take a picture and/or a video of themselves. The light source and camera can be controlled by a mobile application that is in wireless electrical communication via a transmitter.

In this manner, the smart mirror device of the present invention accomplishes all the foregoing objectives and provides an improved mirror. In doing so, the device provides adequate lighting and allows a user to take a photo or video using the mirror without having their smart device in the picture. In addition, the ability to take a photo or a video allows a user to see a 360-degree view of their entire outfit.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart mirror device primarily comprised of a frame with a first side having at least one first mirror with at least one light source and a second side having at least one second minor with at least one camera. In the preferred embodiment, the device is generally rectangular in shape and has at least one leg attached to each side via at least one pivot point. The pivot point is preferably (but not limited to) a pivot pin that allows the frame to spin 360 degrees while supported by both legs in a free-standing manner.

The first side is comprised of at least one minor. On the first side, the frame and/or mirror is comprised of at least one light source that is preferably an LED light that can illuminate any color and illumination pattern. The light source may be positioned outside of the frame or may be embedded into the frame. The second side is also comprised of at least one mirror having at least one light source that is preferably an LED light that can illuminate any color and illumination pattern. The light source may be positioned outside of the frame or may be embedded into the frame.

The second side is also comprised of at least one camera. The camera is in wired or wireless electrical communication with at least one transmitter. The transmitter is in wireless electrical communication with at least one mobile application via a Wi-Fi connection, Bluetooth connection, etc.

The mobile application can be used on any smart device such as, but not limited to, a computer, a cell phone, a tablet, etc. The mobile application has several features including allowing a user to control the light source on either side of the minor. This allows a user to change the color, brightness, illumination pattern, etc., of each light source. The mobile application also allows a user to take a photo or a video using the camera. This allows a user to view a photo/video of their outfit on the mobile application.

Accordingly, the smart mirror device of the present invention is particularly advantageous as it provides an improved mirror with adequate lighting that allows a user to take a photo or video using the mirror without having their smart device in the picture. In addition, the ability to take a photo or a video allows a user to see a 360-degree view of their entire outfit. In this manner, the smart mirror device overcomes the limitations of existing mirrors known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a smart mirror device of the present invention in accordance with the disclosed architecture;

FIG. 2 illustrates a rear view of one potential embodiment of a smart minor device of the present invention in accordance with the disclosed architecture; and

FIG. 3 illustrates a graphical view of functions of a mobile application of one potential embodiment of a smart minor device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved minor. More specifically, there exists a long-felt need in the art for a smart mirror device. There also exists a long-felt need in the art for a smart mirror device that provides adequate lighting. In addition, there exists a long-felt need in the art for a smart mirror device that allows a user to take a photo or video using the mirror without having their smart device in the picture. Further, there exists a long-felt need in the art for a smart minor device that can show a user a 360-degree view of their entire outfit.

The present invention, in one exemplary embodiment, is comprised of a smart minor device. The device is primarily comprised of a frame with a first side having at least one first mirror with at least one light source and a second side having at least one second mirror with at least one camera. The device is preferably rectangular in shape and has at least one leg attached on each side via at least one pivot point that allows the frame to spin 360 degrees while supported by both legs in a free-standing manner.

The first side is comprised of at least one minor. On the first side, the frame and/or mirror are comprised of at least one light source that is preferably an LED light that can illuminate any color and illumination pattern. The light source may be positioned outside of the frame or may be embedded into the frame. The second side is also comprised of at least one minor having at least one light source that is preferably an LED light that can illuminate any color and illumination pattern. The light source may be positioned outside of the frame or may be embedded into the frame.

The second side is also comprised of at least one camera that is in wired or wireless electrical communication with at least one transmitter. The transmitter is in wireless electrical communication with at least one mobile application via a Wi-Fi connection, Bluetooth connection, etc.

The mobile application can be used on any smart device such as, but not limited to, a computer, a cell phone, a tablet, etc. The mobile application has several features including allowing a user to control the light sources on either side of the mirror. This allows a user to change the color, brightness, illumination pattern, etc., of each light source. The mobile application also allows a user to take a photo or a video using the camera. This allows a user to view a photo/video of their outfit on the mobile application.

Accordingly, the smart mirror device of the present invention is particularly advantageous as it provides an improved mirror with adequate lighting that allows a user to take a photo or video using the mirror without having their smart device in the picture. In addition, the ability to take a photo or a video allows a user to see a 360-degree view of their entire outfit. In this manner, the smart mirror device overcomes the limitations of existing mirrors known in the art.

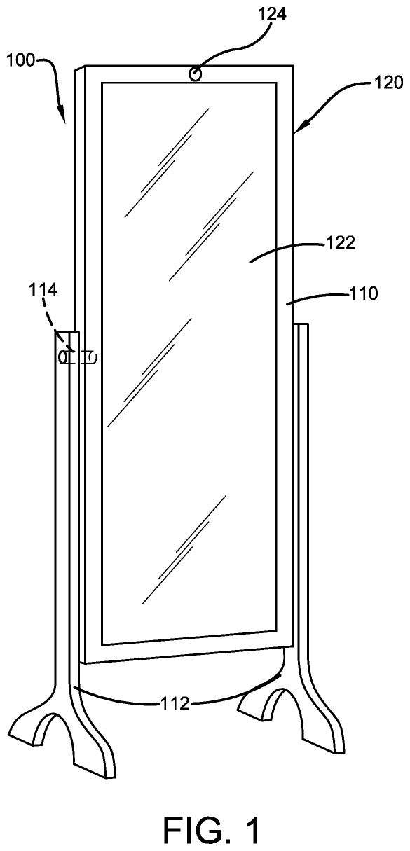

Referring initially to the drawings, FIG. 1 illustrates a front view of one potential embodiment of a smart mirror device 100 of the present invention in accordance with the disclosed architecture. The device 100 is primarily comprised of a frame 110 with a first side 120 having at least one first mirror 122 with at least one light source 124 and a second side 130 having at least one second mirror 132 with at least one camera 136. In the preferred embodiment, the device 100 is generally rectangular in shape. However, the device 100 may be any shape in different embodiments. In one embodiment, the frame 110 can be wall mounted. In the preferred embodiment, the frame 110 has at least one leg 112 attached on each side via at least one pivot point 114. The pivot point 114 is preferably (but not limited to) a pivot pin that allows the frame 110 to spin 360 degrees while supported by both legs 112 in a free-standing manner. The legs 112 and the frame 110 may be any leg style, shape, and size known in the art. The legs 112 and frame 110 may be made from any natural or synthetic material known in the art such as, but not limited to, wood, metal, plastic, etc.

The first side 120 is comprised of at least one mirror 122. The mirror 122 may be any mirror type known in the art such as, but not limited to, a plane minor, a spherical mirror, a non-reversing mirror, a silvered mirror, a non-breakable mirror, etc. The mirror 122 may be any shape but is preferably the same shape as the frame 110. On the first side 120, the frame 110 and/or mirror 122 are comprised of at least one light source 124. The light source 124 is preferably an LED light that can illuminate any color and illumination pattern. The light source 124 may be positioned outside of the frame 110 or minor 122 or may be embedded into the frame 110 or minor 122.

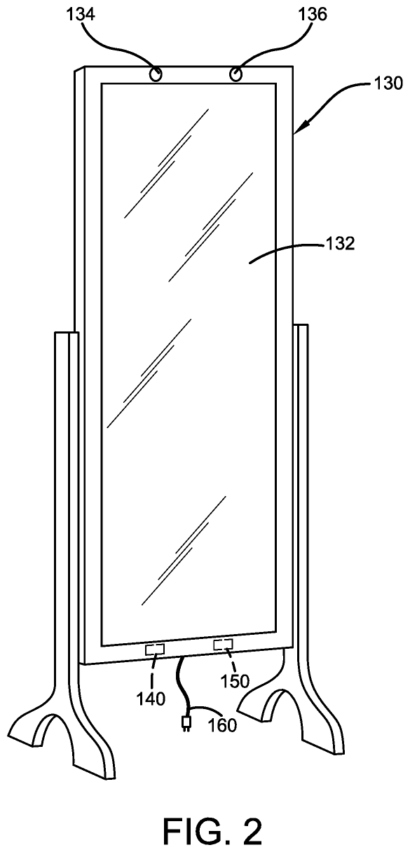

FIG. 2 illustrates a rear view of one potential embodiment of a smart mirror device 100 of the present invention in accordance with the disclosed architecture. Similarly, the second side 130 is comprised of at least one mirror 132. The minor 132 may be any minor type known in the art such as, but not limited to, a plane mirror, a spherical mirror, a non-reversing mirror, a silvered mirror, a non-breakable mirror, etc. The minor 132 may be any shape but is preferably the same shape as the frame 110. On the second side 130, the frame 110 and/or minor 132 are comprised of at least one light source 134. The light source 134 is preferably an LED light that can illuminate any color and illumination pattern. The light source 134 may be positioned outside of the frame 110 or minor 132 or embedded into the frame 110 or mirror 132.

The second side 130 is also comprised of at least one camera 136. The camera 136 may be positioned on or embedded within the frame 110 or mirror 132. The camera 136 is in wired or wireless electrical communication with at least one transmitter 140. The transmitter 140 is in wireless electrical communication with at least one mobile application 200 via a Wi-Fi connection, Bluetooth connection, etc.

The light sources 124,134 and camera 136 are powered by at least one battery 150. The battery 150 may be a disposable battery 150 or a rechargeable battery 150 in the form of an alkaline, nickel-cadmium, nickel-metal hydride battery 150, etc., such as any 3V-12 volts DC battery 150 or other conventional battery 150 such as A, AA, AAA, etc., that supplies power to the device 100. Throughout this specification the terms “battery” and “batteries” may be used interchangeably to refer to one or more wet or dry cells or batteries 150 of cells in which chemical energy is converted into electricity and used as a source of DC power. References to recharging or replacing batteries 150 may refer to recharging or replacing individual cells, individual batteries 150 of cells, or a package of multiple battery cells as is appropriate for any given battery 150 technology that may be used. The battery 150 may receive power via at least one power cord 160 that can be plugged into a 110 v/240 v outlet.

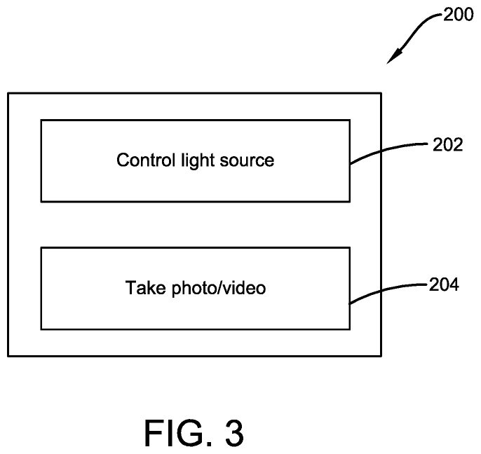

FIG. 3 illustrates a graphical view of functions of a mobile application 200 of one potential embodiment of a smart mirror device 100 of the present invention in accordance with the disclosed architecture. As noted supra, the camera 136 is in wireless electrical communication with a mobile application 200 via the transmitter 140. The mobile application 200 can be used on any smart device such as, but not limited to, a computer, a cell phone, a tablet, etc. The mobile application 200 has several features. First, the mobile application 200 allows a user to control the light sources 202 on either side 120,130 of the mirror. This allows a user to change the color, brightness, illumination pattern, etc., of each light source 124,134. The mobile application 200 also allows a user to take a photo or a video 204 using the camera 136. Using this feature, a user can activate a count-down timer that will automatically take a photo or a video from the camera 136. The timer has a countdown period of at least one second. This allows a user to view a photo/video of their outfit on the mobile application 200.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart mirror device” and “device” are interchangeable and refer to the smart mirror device 100 of the present invention.

Notwithstanding the foregoing, the smart mirror device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the smart mirror device 100 as shown in the FIGS. are for illustrative purposes only, and that many other sizes and shapes of the smart mirror device 100 are well within the scope of the present disclosure. Although the dimensions of the smart mirror device 100 are important design parameters for user convenience, the smart mirror device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart mirror device comprising:
a frame;
a leg;
a battery;
a transmitter;
a light source;
a power cord;
a first side comprised of a first mirror;
a second side comprised of a second mirror; and
a mobile application.

2. The smart mirror device of claim 1, wherein the light source is positioned on the first side.

3. The smart mirror device of claim 1, wherein the light source is positioned in the frame.

4. The smart mirror device of claim 1, wherein the light source is positioned on the frame.

5. The smart mirror device of claim 1, wherein the light source is positioned on the first mirror.

6. The smart mirror device of claim 1, wherein the light source is positioned in the first mirror.

7. A smart mirror device comprising:
a frame;
a leg attached to the frame via a pivot point;
a battery;
a transmitter;
a power cord;
a first side comprised of a first mirror comprised of a first light source;
a second side comprised of a second mirror comprised of a second light source; and
a mobile application.

8. The smart mirror device of claim 7, wherein the power cord is comprised of a 110 v or 240 v male power cord.

9. The smart mirror device of claim 7, wherein the camera is in electrical communication with the transmitter.

10. The smart mirror device of claim 7, wherein the transmitter is in wireless electrical communication with the mobile application.

11. A smart mirror device comprising:
a first leg;
a second leg;
a frame that attaches to the first leg and the second leg via a first pivot point and a second pivot point;
a battery;
a transmitter;
a power cord;
a first side comprised of a first mirror comprised of a first light source; and
a second side comprised of a second mirror comprised of a second light source; and
a mobile application.

12. The smart mirror device of claim 11, wherein the mobile application controls a color of the first light source and a color of the second light source.

13. The smart mirror device of claim 11, wherein the mobile application controls a brightness of the first light source and a brightness of a second light source.

14. The smart mirror device of claim 11, wherein the mobile application controls an illumination pattern of the first light source and an illumination pattern of the second light source.

15. The smart mirror device of claim 11, wherein the mobile application is comprised of a countdown timer feature.

16. The smart mirror device of claim 15, wherein the countdown timer feature controls the camera.

17. The smart mirror device of claim 15, wherein the camera can take a photo or a video after a time period of the countdown timer feature has ended.

18. The smart mirror device of claim 17, wherein the time period is at least 1 second.

19. The smart mirror device of claim 11, wherein the first pivot point and the second pivot point are comprised of a pivot pin.

20. The smart mirror device of claim 11, wherein the frame rotates 360 degrees around the first pivot point and the second pivot point.
